(19) United States
(12) Patent Application Publication
(10) Pub. No.: US 2009/0057635 A1
(43) Pub. Date: Mar. 5, 2009

(54) Motorcycle righting jack

(76) Inventor: Dale F. Klco, Lake Worth, FL (US)

Correspondence Address: BENASUTTI, P.A., 17294 BERMUDA VILLAGE DRIVE, BOCA RATON, FL, 33487, US

(21) Appl. No.: 12/229,081

(22) Filed: Aug. 20, 2008

Related U.S. Application Data
(60) Provisional application No. 60/966,850, filed on Aug. 30, 2007.

(51) Int. Cl. B66F 3/08; B66F 5/00

(52) U.S. Cl. 254/7 R; 254/424; 254/134

(57) ABSTRACT

A motorcycle jack is described which allows an individual to right a motorcycle which has been downed, by themselves. The jack has a cradle, which maintains its horizontal disposition while the jack raises the bike from beneath the foot board bracket.

### CROSS REFERENCE TO RELATED APPLICATION

This application is a continuation-in-part of my prior to copending application Ser. No. 60/966,850 filed Aug. 30, 2007 entitled Motorcycle Righting Jack the disclosure of which is incorporated herein by reference as if fully set forth.

### BACKGROUND OF THE INVENTION

1. Technical Field

This invention relates to jacks; and more particularly, a jack for restoring a downed motorcycle to an upright position.

2. Background Art

Prior art jacks for automobiles have either a bed centrally mounted above a scissors frame or a centrally mounted single post.

Trolley or floor jacks are also known. These have wheels. However, their profiles are greater than three inches at a minimum.

There are also bumper jacks, which have a hook mounted to be ratcheted-up a shaft having a triangular cross-section.

As far as the present inventor knows, the only means of raising a downed motorcycle (as shown schematically in FIG. 1), is to grab it by a portion of its frame and lift it so as to pivot it about the edges of its tires until it is upright. In many cases, this is virtually impossible to do single handedly.

### SUMMARY OF INVENTION

I have invented a jack which is designed to be inserted in the narrow space between the ground and a portion of the frame, known as the foot board bracket, of the downed motorcycle. A cradle near the end of the jack is designed to engage that frame member on the motorcycle as the jack is expanded and thereby raise the motorcycle to its upright position. This jack makes it possible for a person acting alone to raise the bike.

### BRIEF DESCRIPTION OF THE DRAWINGS

FIG. 1 is a schematic view of a motorcycle shown in three positions;

FIG. 2 is a perspective view of a jack in accordance with my invention when viewed from the left front;

FIG. 3 is a perspective view of the jack shown in FIG. 2, when rotated 180° and partially opened;

FIG. 4 is a side view of my motorcycle jack, showing it in three positions corresponding to the three positions shown in FIG. 1;

FIG. 5 is a side view of my jack in another position, fully opened;

FIG. 6 is an exploded view of the parts of my jack; and

FIG. 7 is a perspective view of a part of the jack.

### DESCRIPTION OF THE PREFERRED EMBODIMENTS

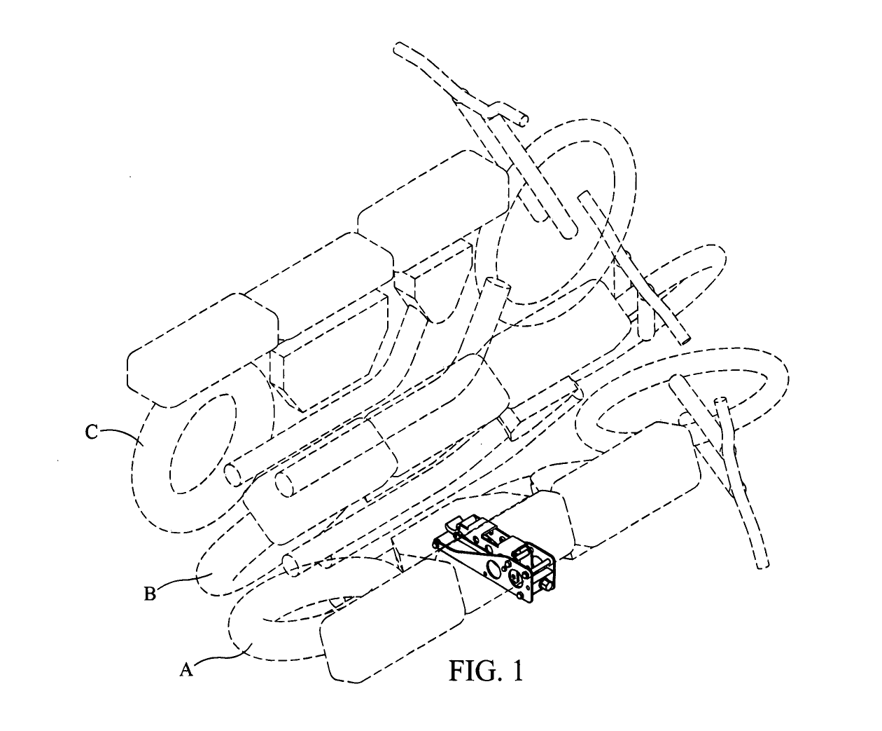

Referring to the figures, FIG. 1 shows schematically a motorcycle designated generally 10 in three positions. In position “A” the motorcycle is laying on its side. This is known as the downed condition. In position “B” the motorcycle is partially raised and in position “C” the motorcycle is fully raised or upright.

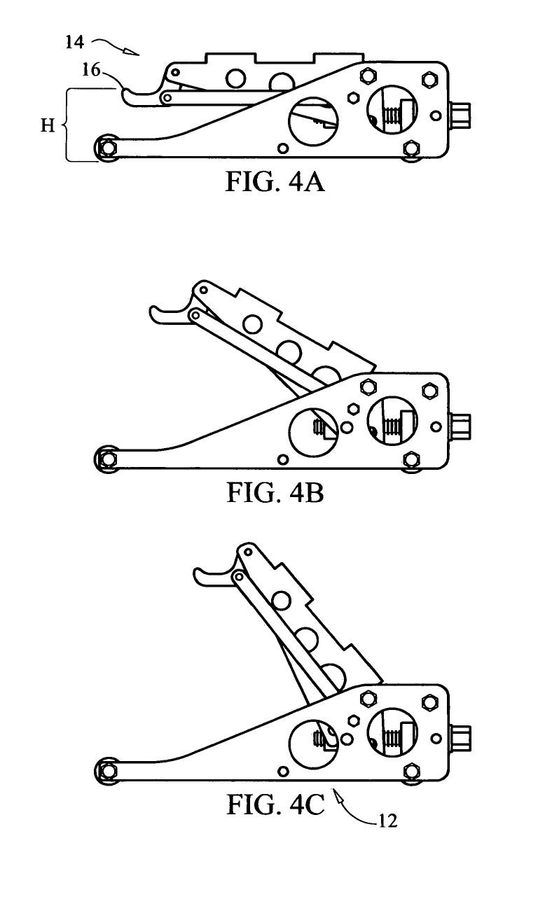

FIG. 4 illustrates these three conditions of my motorcycle jack (designated generally 12) when it is being used to raise a downed motorcycle. In position “A” the jack has been inserted under the foot board bracket of the motorcycle which has fallen on its side and is lying on the ground. In this condition there is very little room between the frame of the bike and the ground. In the condition shown, the jack has already been slightly expanded toward the bottom of the foot board of the motorcycle.

The jack 12 that I have invented is designed to fit into this space by providing an assembly with a leading end, designated generally 14. The front wheel 32 of the jack assembly has a diameter, most preferably, of approximately 1.125 inches. When fully retracted or collapsed, the cradle 16 fits within the space between the side members 18 of the yoke 36 and is dimensions so as to be less than the diameter of the wheel 32. Thus the minimal height of the front end “H” is 1.125 inches.

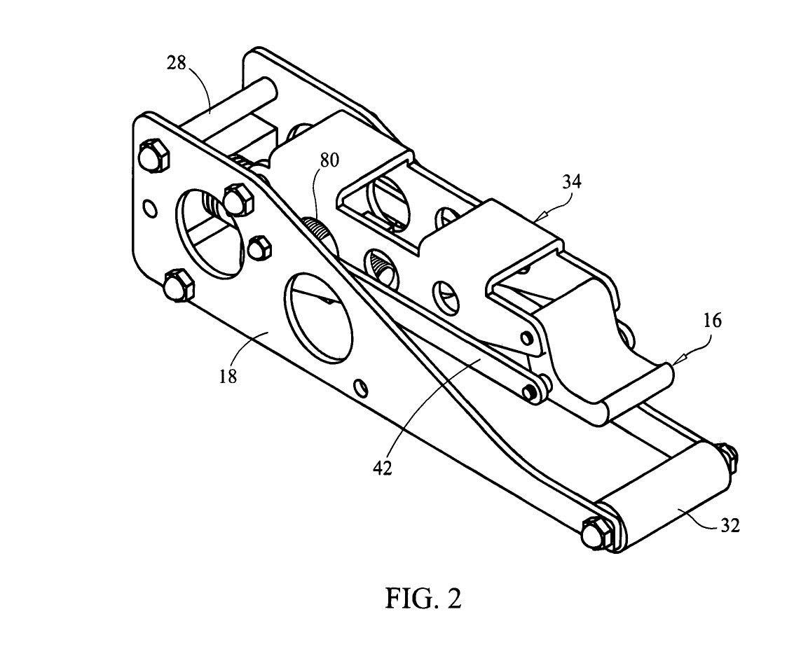

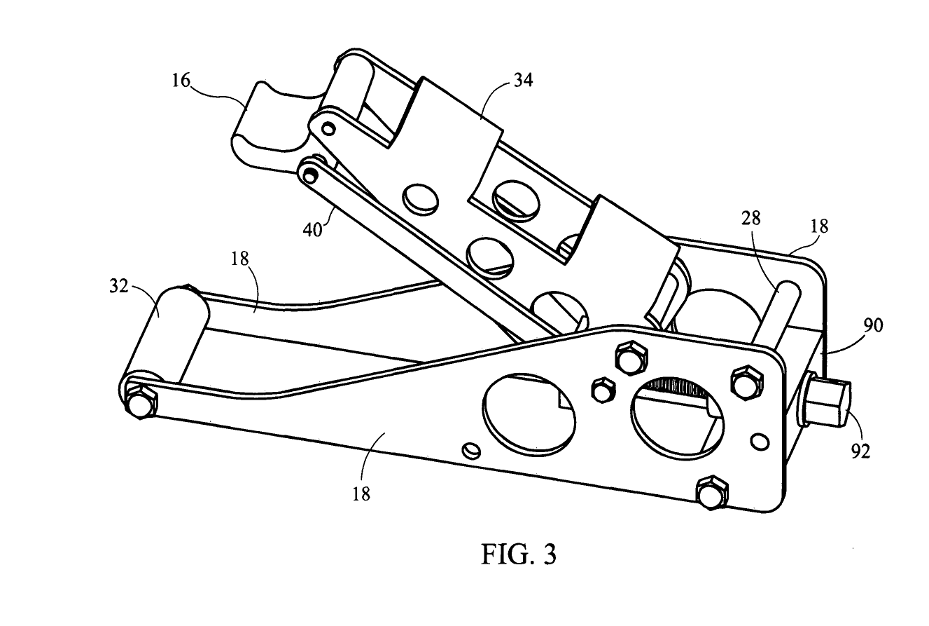

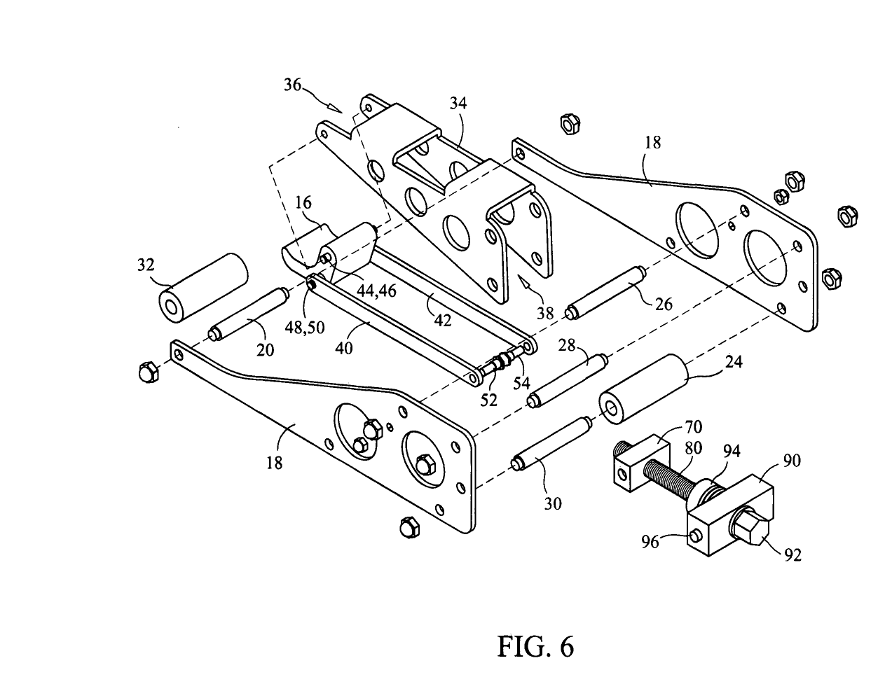

The jack assembly is shown in perspective views FIGS. 2 and 3 and in an exploded perspective view in FIG. 6. Within this end 14 of the assembly I have provided a cradle means 16 supported at its lower end by the ends of bracket arms 40 and 42 and pins 48 and 50.

A yoke 34 is provided, which has a leading end designated generally 36 and a rear end designated generally 38. The upper end of the cradle means 16 is mounted for rotation in the leading end of the yoke 36 by pins 44 and 46.

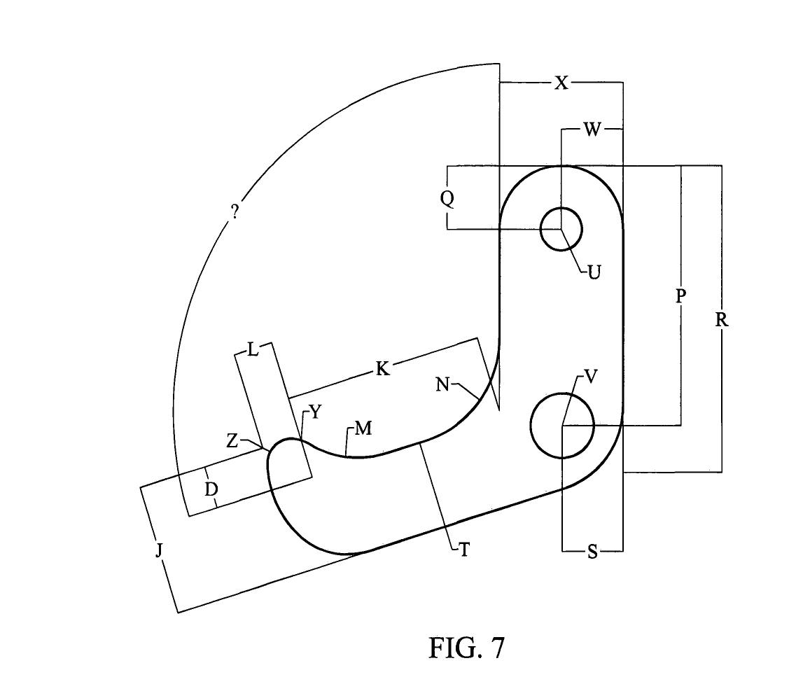

The dimensions of the cradle means 16 are optimally shown in FIG. 7. In that figure the cradle dimensions are as follows: J 0.75 inches; K 1.25 inches; L 0.25 inches; M a radius of 0.63 inches; N a radius of 0.63 inches; P 1.49 5 inches; Q 0.375 inches; R 1.75 inches; S 0.375 inches; T 0.5 inches; U a diameter of 0.25 inches; V a diameter of 0.375 inches; W 0.375 inches; X 0.75 inches; Y a radius of 0.15 inches; and Z a radius of 0.15 inches. The cradle body is approximately two inches wide; has a depth D of approximately 0.25 inches; and is approximately 1.25 inches from front to back. The inner surface of the cradle is curved in the front and the back from the bottom to the top.

The front wheel 32 is in the form of a roller to handle the load. A two wheel jack would sink into asphalt or turf in a non-uniform manner.

These dimensions and the positioning of the cradle means 16 within the assembly are required in order to achieve the height requirements and in order enable the motorcycle to be uniformly raised in an arcuate motion.

The bracket arms 40 and 42 are mounted for rotation within the side plates 18. The side plates 18 are spaced from one another by means of the spacer 24 at the rear and the wheel shaft 20 at the front. Pins 26, 28 and 30 as well as a wheel shaft 20 retain these side plates in a fixed frame.

The yoke 34 is positioned to rotate about the spacer pin 26 as shown in FIG. 6. This pivoting action is cause by the following mechanism. A pivot block 70 is positioned between the lower ears of the yoke back portion 38 and can be pivoted. Block 70 is threatedly engaged with lead screw 80. The lead screw has an ACME threads which is most preferably rolled for smother operation.

The other end of the lead screw 80 is retained in a back block 90. This back block 90 is position for rotation within the side plates 18 by means of pins 96, 98. A retainer 94 holds the lead screw 80 in the back block 90, so that when the nut 92 (fixed to the lead screw) is turned, the lead screw turns and moves the block 70 toward or away from it away from the back block. This action pivots the yoke 34 so that the cradle 16 is raised or lowered while maintaining its horizontal disposition.

The rear ends of the bracket arms 40 and 42 are mounted for rotation to the side plates 18 by means of lift link pins 52 and 54.

In its preferred embodiment, the cradle means 16 is specifically dimensioned and configured to provide a means for engaging the passenger foot board bracket of a motor cycle in such a manner that it will maintain its engagement therewith while the bike is being raised in an arcuate motion. On a hard surface the wheels allow the jack to move inward toward the motorcycle as the motorcycle is being lifted. (See FIGS. 1 and 4). Normally when the jack is extended a height of ten or eleven inches, that is a sufficient height to enable a person to raise the bike to a stable condition by themselves. The jack must be positioned to engage the bike frame such that when force is applied to the frame, the bike will pivot about the edges of its wheels as it is raised.

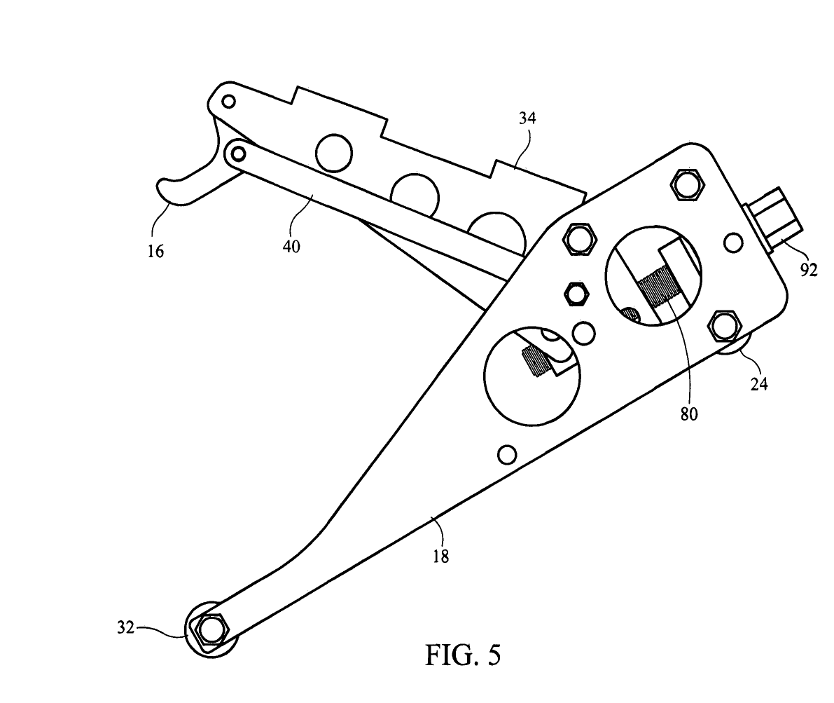

FIG. 5 shows the condition wherein the jack is raising a motorcycle which has been downed in turf. On soft or irregular surfaces, the jack will tilt inward as the bike is being lifted. In such a condition, the front roller 32 bytes into the turf; but the jack is nevertheless able to maintain the horizontal position of its cradle by rotating about the shaft which retains the front wheel 32.

From what I have described, I have invented a motorcycle jack, comprising: a cradle means; an expandable frame assembly means having a front and back and a base, engaging said cradle means for raising said cradle means relative to said base; a roller means mounted in and supporting said expandable frame assembly means for permitting a said expandable frame assembly means to move laterally in the direction of its front, while it is being expanded to raise said cradle means; and said expandable frame assembly means including said roller means and said cradle means having dimensions such that the cradle means fits within the front end of the expandable frame assembly when lowered to be so positioned; said roller providing a maximum overall height dimension at the front end of the expandable frame assembly means of approximately 1.125 inches.

In my jack of the expandable frame assembly means further provides a means for raising the cradle means while maintaining the cradle means in a horizontal disposition.

The cradle means has a cradle body providing a cradle approximately 0.25 inches deep and approximately 2 inches wide and is approximately 1.25 inches from front to back.

The cradle means has an inside surface, curved in its front and back, from bottom to top.

1. A motorcycle jack, comprising:
a cradle means;
an expandable frame assembly means having a front and back and a base, engaging said cradle means for raising and lowering said cradle means relative to said base;
a roller means mounted in and supporting said expandable frame assembly means for permitting a said expandable frame assembly means to move laterally in the direction of its front, while it is being expanded to raise said cradle means;
said expandable frame assembly means including said roller means and said cradle means having dimensions such that the cradle means fits within the front end of the expandable frame assembly when lowered to be so positioned.

2. The jack of claim 1 wherein the expandable frame assembly means further provides a means for raising the cradle means while maintaining the cradle means in a horizontal disposition.

3. The jack of claim 1 wherein the roller means has a roller having a diameter of approximately 1.125 inches.

4. The motorcycle jack of claim 1 wherein the cradle means has a cradle body providing a cradle approximately 0.25 inches deep and approximately 2 inches wide and is approximately 1.25 inches from front to back.

5. The cradle means of claim 4 having an inside surface, curved in its front and back, from bottom to top.
